(19) United States
(12) Patent Application Publication
(10) Pub. No.: US 2009/0222277 A1
(43) Pub. Date: Sep. 3, 2009

(54) DEFINING AND IMPLEMENTING CUSTOM TASK PROCESSES

(75) Inventors: Alexander Hussain Malek, Seattle, WA (US); Phillip David Allen, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/041,623

(22) Filed: Mar. 3, 2008

(51) Int. Cl. G06Q 10/00; G06F 3/048

(52) U.S. Cl. 705/1; 715/810

(57) ABSTRACT

Concepts and technologies are provided herein for defining and implementing custom task processes. An authoring tool provides a user interface for defining a custom task process that encompasses one or more task instances. New workflow logic can be applied to both the task action and the encompassed task instances. Once a task process has been defined using the authoring tool, a workflow that includes the task process is submitted to a collaborative application for execution. The defined task action and task instances are executed by the collaborative application to implement the defined task process. Through the execution of the task process, assignments are made to the defined participants, and additional workflows, actions, and behaviors may be triggered and executed based upon the defined task action and task instances.

### BACKGROUND

A workflow defines a series of tasks within an organization to produce a final outcome. Workflows allow for business process formalization and management. A collaborative workgroup computing application allows different workflows to be defined for different types of jobs. For example, in a publishing setting, a document may be automatically routed from writer to editor to proofreader to production. At each stage in the workflow, one individual or group is responsible for a specific task. Once the task is complete, the workflow application ensures that the individuals responsible for the next task are notified and receive the data needed to execute the next stage of the process.

A workflow schedule authoring tool enables a user to author a workflow by arranging building blocks in a particular order. Building blocks may correspond to events, conditions, or actions. Each building block is associated with source code that defines an action to be taken when the building block is executed. The order of the building blocks determines the workflow schedule process that will be performed when the workflow schedule is executed by a workflow execution engine on a server computer. Some building blocks may be predefined for commonly used actions. Other building blocks may be customized to execute a specific function or to provide a solution to a unique problem. The building blocks simplify workflow schedule authoring because the user does not need to write any code.

Previous workflow schedule authoring tools provide significant functionality for modeling a wide variety of real-world business processes. However, the previous workflow authoring tools provide limited functionality for defining and modeling human workflow-specific scenarios, particularly task processes in the area of approval and feedback collection. In previous workflow authoring tools, much of the task processes that users would like to model is hidden within a generic task assignment object. As an example, in some scenarios where time is of the essence, rejection is automatic if a document is not approved after a certain amount of time has passed. This type of logic cannot be defined utilizing previous workflow schedule authoring tools. While some workflow authoring tools do provide predefined building blocks for approval and feedback tasks, these predefined building blocks are not customizable. As a result, the predefined building blocks are unusable if they do not perform the desired workflow.

It is with respect to these considerations and others that the disclosure made herein is provided.

### SUMMARY

Concepts and technologies are provided herein for defining and implementing custom task processes. Through the embodiments presented herein, facilities are provided for declaratively defining a task process workflow action that permits flexible modeling of approval and feedback collection processes without writing program code. The embodiments presented herein also provide functionality for customizing predefined building blocks for approval and feedback tasks to more closely model actual task processes within an organization.

According to one aspect presented herein, a workflow schedule authoring tool (referred to herein as the “authoring tool”) is provided that includes a user interface and associated functionality for creating workflow schedules by arranging building blocks, called workflow actions, in a particular order. Workflow actions may correspond to events that trigger the workflow, effects the workflow should have on a collaborative workflow group application system, or conditional logic processing logic that determines the control of the workflow. The authoring tool is executed at a client computer and workflow schedules created at the client computer are transmitted to a server computer for execution.

According to one aspect, the authoring tool provides a user interface for defining a custom task process action within a workflow. The custom task process may correspond to an approval process, a feedback process, or a to-do process. An approval process is a process that involves participants approving a document or other item, a feedback process is a process that involves participants providing feedback on a document or other item, and a to-do process is a process by which a task is assigned to one or more participants. The technologies presented herein can be utilized to flexibly define and implement each of these process types and others.

According to other aspects, the user interface provided by the authoring tool includes functionality for defining a task action for the custom task process that encompasses one or more task instances. New workflow logic can be applied to both the task action and the encompassed task instances. For instance, in one embodiment, the user interface can be utilized to define process behaviors and completion conditions that apply to the task action. Process behaviors are event handlers that execute in response to an event occurring in the context of the task action. Completion conditions are event handlers that execute in response to the completion of a task instance encompassed by a task action.

According to other aspects, the user interface provided by the authoring tool also includes functionality for defining the task instances encompassed by a task action. For instance, one or more task behaviors may be defined for each task instance. Task behaviors are event handlers that execute in response to an event occurring in the context of a task instance. The user interface may also be utilized to define form fields for receiving data from a participant in the custom task process, task outcomes to be received from a participant in the custom task process, and task settings defining whether a participant can delegate a task instance or request a change of a task instance. Once a task process has been defined using the authoring tool, a workflow that includes the task process is submitted to a collaborative application for execution. The defined task action and task instances are executed by the collaborative application to implement the defined task process. Through the execution of the task process, assignments are made to the defined participants, and additional workflows, actions, and behaviors may be triggered and executed based upon the defined task action and task instances.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network and software diagram showing an illustrative operating environment for the processes and computer systems described herein and several of the software components provided herein in embodiments;

FIG. 2 is a software architecture diagram showing aspects of a task action and several task instances disclosed by embodiments presented herein;

FIG. 3 is a flow diagram illustrating aspects of the operation and use of the task action and task instances shown in FIG. 2 in one embodiment presented herein;

FIGS. 4-10 are screen diagrams showing illustrative user interfaces provided by an authoring tool for defining a task action and task instances in various embodiments presented herein; and

FIG. 11 is a computer architecture diagram showing aspects of a computer suitable for executing the various software components described herein.

### DETAILED DESCRIPTION

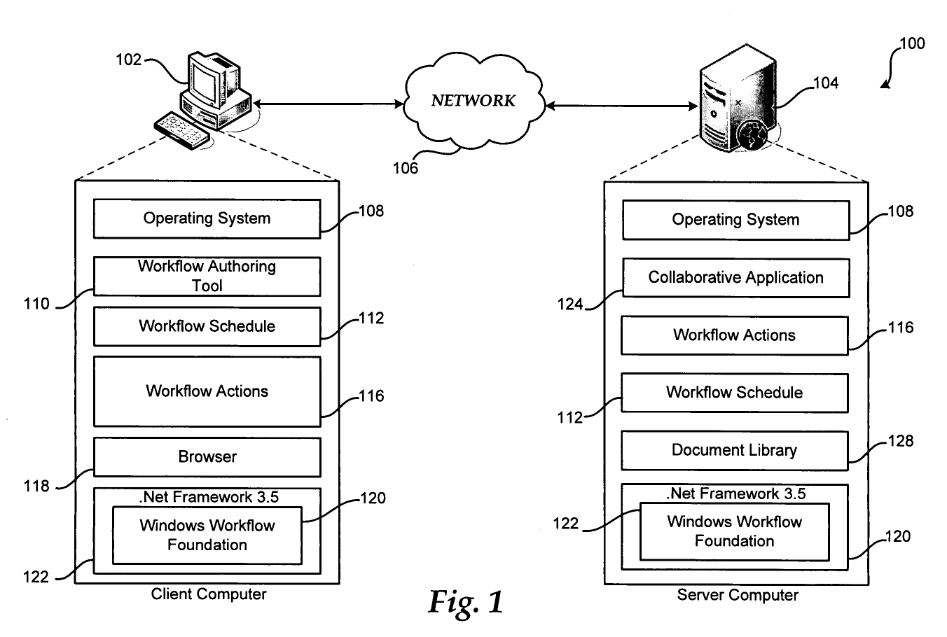

The following detailed description is directed toward technologies for defining and implementing custom task processes. As will be described in greater detail herein, a workflow schedule authoring tool is provided that allows a task process workflow action to be defined that enables flexible modeling of approval and feedback collection processes. In this way, approval and feedback tasks can be defined and implemented that closely model the actual task processes utilized within an organization. Additional details regarding the concepts and technologies presented herein are disclosed below with respect to FIGS. 1-11.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The subject matter presented herein is also described as being practiced in a distributed computing environment where tasks are performed by remote processing devices that are linked through a communications network and wherein program modules may be located in both local and remote memory storage devices. It should be appreciated, however, that the implementations described herein may also be utilized in conjunction with stand-alone computer systems and other types of computing devices. It should also be appreciated that although reference is made herein to the Internet, the embodiments presented herein may be utilized with any type of local area network (“LAN”) or wide area network (“WAN”).

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for defining custom task processes will be described. In particular, FIG. 1 is a network diagram illustrating aspects of an illustrative operative environment for the subject matter described herein that includes a client computer 102, a network 106, and a server computer 104.

As shown in FIG. 1, the client computer 102 and the server computer 104 are communicatively coupled to one another through respective connections to the network 106. According to one implementation, the network 106 comprises the Internet. However, it should be appreciated that the network 106 may comprise a LAN, WAN, or other type of network suitable for connecting the client computer 102 and the server computer 104.

FIG. 1 also illustrates a number of software components utilized by the client computer 102 and the server computer 104. In particular, the client computer 102 includes an operating system 108 suitable for controlling the operation of a networked desktop or laptop computer. The server computer 104 includes an operating system 108 suitable for controlling the operation of a networked server computer. For instance, according to implementations, the server computer 104 utilizes the WINDOWS SERVER 2008 operating system from MICROSOFT CORPORATION of Redmond, Wash. In implementations, the client computer 102 may utilize one of the WINDOWS XP, WINDOWS VISTA, WINDOWS SERVER 2003, or WINDOWS SERVER 2008 operating systems, also from MICROSOFT CORPORATION. Other operating systems, such as the LINUX operating system or the OSX operating system from APPLE COMPUTER, INC. may be utilized by the client computer 102 and the server computer 104. It should be appreciated that although the embodiments presented herein are described in the context of a desktop or laptop client computer 102 and a remote server computer 104, many other types of computing devices and systems may be utilized to embody the various aspects presented herein. It should also be appreciated that, in one embodiment, the client computer 102 and the server computer 104 comprise the same computing system.

According to one implementation, the client computer 102 also includes a Web browser program (referred to herein as a “browser”) 118. The browser 118 is operative to request, receive, and display information pages, such as Web pages, from the server computer 104. In particular, the browser 118 is operative to establish a connection to a collaborative application 124 executing on the server computer 104. Through the connection, the browser 118 may request information pages provided by the collaborative application 124. The collaborative application 124 is a computer software program that enables multiple users to collaborate on documents, projects, tasks, and other matters.

The collaborative application 124 also supports workflow processes. In general, a workflow is an abstraction of how work flows through a business process. This abstract notion of workflow has been modeled in computer programs and computer software for supporting workflow through a business process has become known as “workflow.” Hereinafter, the term workflow refers to such a software model (i.e., a software program that supports the modeling of how work flows through a business process). It should be appreciated, that the implementations described herein may be utilized with any type of computer system that supports workflow processes.

In order to support the provision of workflow, in one implementation the server computer 104 includes the .NET FRAMEWORK 3.5 122 from MICROSOFT CORPORATION. The .NET FRAMEWORK 3.5 122 is a framework for building, deploying, and running Web services and other applications. The .NET FRAMEWORK 3.5 122 includes the WINDOWS WORKFLOW FOUNDATION (“WF”) 120. The WF 120 is a programming model, engine, and tools for building and executing workflow enabled applications. The WF 120 allows a developer to more easily model and support business processes. Details regarding the .NET FRAMEWORK 3.5 122 and the WF 120 are publicly available from the MICROSOFT DEVELOPERS NETWORK (“MSDN”) and from other sources.

The WF 120 includes a workflow engine for instantiating and executing instances of workflows created using authoring tools, such as the workflow authoring tool 110. The workflow engine runs a workflow by advancing the workflow through a workflow schedule 112. The workflow schedule 112 is a data structure containing data that identifies the workflow actions 116 that should be executed as a part of the workflow, workflow logic, and various metadata. As will be described in greater detail below, the workflow authoring tool 110 may be utilized to author the workflow schedule 112. The workflow schedule 112 may then be transmitted to the server computer 104 for execution as a part of the collaborative services provided by the collaboration application 124. Additional details regarding this process are provided below.

As shown in FIG. 1, the client computer 102 also includes the .NET FRAMEWORK 3.5 122 and WF 120 for use during the workflow authoring process described herein. It should be appreciated that although the implementations presented herein are described in the context of the .NET FRAMEWORK 3.5 122 and the WF 120, other similar programming frameworks and workflow modeling tools available from other manufacturers may be utilized on the client computer 102 and server computer 104 to implement the embodiments presented herein.

As discussed briefly above, the client computer 102 is operative to execute a workflow authoring tool 110. The authoring tool 110 is an application program that provides facilities for visually creating workflows that can be executed by the collaborative application 124. In particular, through the facilities provided by the authoring tool 110, a user can graphically create a workflow schedule 112. The workflow schedule 112 references various workflow actions 116 that are the building blocks that perform the actual processing for the various steps of the workflow. The workflow actions 116 are executable components that may correspond to events, conditions, or actions within a workflow process. As shown in FIG. 1, the workflow actions 116 are stored on the server computer 104 for use when the workflow schedule 112 is executed. Some of the workflow actions 116 may also be stored on the client computer 102 for use during the authoring of a workflow schedule 112. Once the workflow schedule 112 has been completed, the client computer 102 transmits the workflow schedule 112 to the server computer 104 for storage.

In one implementation, the server computer 104 stores workflow schedules 112 in a versioned document library 128 provided by the collaborative application 124. Once the workflow schedule 112 has been stored in the document library 128, the workflow schedule 112 may be instantiated and executed. This may occur, for instance, in response to the occurrence of an event or in response to a manual request to execute the workflow schedule 112. When the workflow schedule 112 is instantiated, the workflow actions 116 are utilized to perform the actual processing for the workflow.

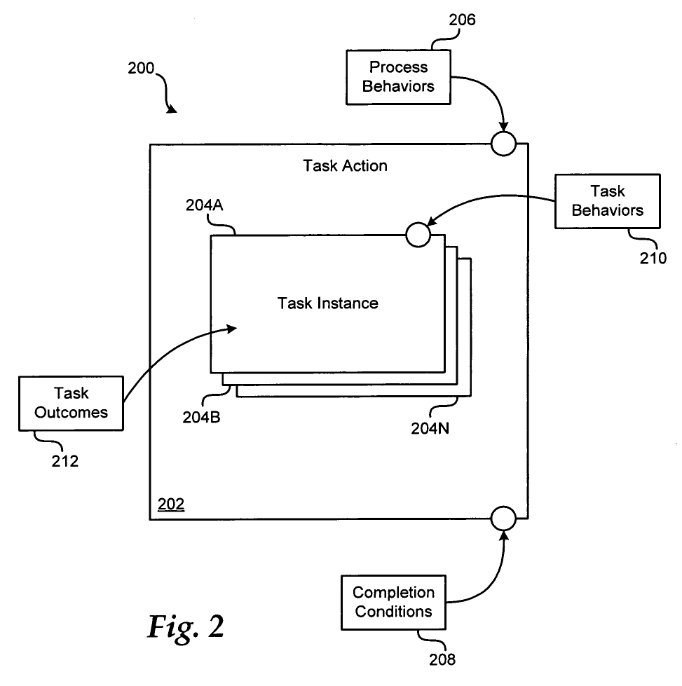

According to aspects presented herein, the authoring tool 110 provides a user interface for defining a custom task process action within a workflow. In embodiments, the custom task process corresponds to an approval process, a feedback process, or a to-do process. Although the examples presented herein primarily describe the creation of an approval task process, the technologies presented herein can be utilized to flexibly define and implement each of these process types and others. Additional details regarding the operation of the authoring tool 110 and the collaborative application 124 for modeling and executing a custom task process are provided below with respect to FIGS. 2-11.

Turning now to FIG. 2, details will be provided regarding the embodiments presented herein for defining and implementing a custom task process. As discussed briefly above, the user interface provided by the authoring tool 110 includes functionality for defining a custom task process action within a workflow. The custom task process action is a type of workflow action that can be used alongside other non-iterative activities, such as sending an e-mail message, within the authoring tool 110.

In one embodiment, the custom task process action is defined by a task action 202 and one or more task instances 204A-204N. The task action 202 represents the overall custom task process action and the task instances 204A-204N represent individual activities occurring within the custom task process action. As will be described in greater detail below, through the use of the authoring tool 110 a user can define workflow logic that applies to both the task action 202 and to the task instances 204A-204N. For instance, through the authoring tool 110 provided herein, a user can define process behaviors 206 and completion conditions 208 that apply to the task action 202. The process behaviors 206 represent event handlers that execute in response to an event occurring in the context of the task action 202. The completion conditions 208 represent event handlers that execute in response to the completion of one of the task instances 204A-204N encompassed by the task action 202.

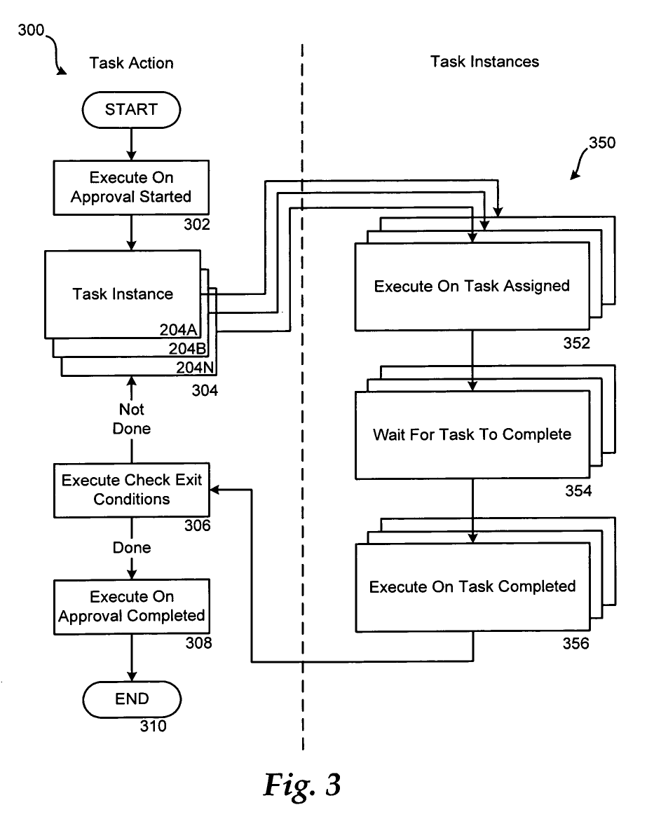

In the embodiments presented herein, a user may also utilize the authoring tool 110 to define task behaviors 210 and task outcomes 212 for each of the task instances 204A-204N. The task behaviors 210 represent event handlers that are executed in response to an event occurring in the context of one of the task instances 204A-204N. The task outcomes 212 define one or more outcomes for a task instance 204A-204N that are to be received from a participant in the custom task process. As will also be discussed in greater detail below, the authoring tool 110 provides functionality for defining one or more form fields that are utilized to receive data from participants in the custom task process. For instance, an e-mail message may be transmitted to a participant that contains the specified form fields for collecting data from the participant. Alternately, an editing application, such as a word processor or spreadsheet application, may expose the form fields for completion by a user that is viewing or editing a document that has a workflow task associated with it. Other settings for the custom task process may also specified utilizing the authoring tool 110, such as settings defining whether a participant can delegate one of the task instances 204A-204N to another participant or request a change of a task instance. Additional details regarding the processes provided herein for defining and executing the task action 202 and the task instances 204A-204N are provided below with respect to FIGS. 3-11.

Referring now to FIG. 3, additional details will be provided regarding the embodiments presented herein for defining and implementing a custom task process. In particular, FIG. 3 shows several routines 300 and 350 that together illustrate aspects of the operation of the collaborative application 124 when executed on the server computer 104 for implementing a custom task process according to one implementation. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 300 shown in FIG. 3 illustrates aspects of the operation of the collaborative application 124 for executing the task action 202. The routine 350 illustrates aspects of the collaborative application 124 for executing the task instances 204A-204N. As illustrated in FIG. 3, the routine 300 begins at operation 302 when the task action 202 is executed. At operation 302, an “on approval started” activity is executed. This activity is executed each time a task action 202 is about to be executed.

Once the “on approval started” activity has been executed, the routine 300 continues to operation 304 where the task instances 204A-204N are instantiated. The routine 350 illustrates the various activities executed in connection with the task instances 204A-204N. In particular, the routine 350 begins at operation 352 where an “on task assigned” activity is executed for each of the task instances 204A-204N. This activity executes each time a task instance 204A-204N is about to be created. The routine 350 then continues to operation 354, where a “wait for task to complete” activity is executed. This activity waits for certain predefined conditions to occur that indicate that a task instance 204A-204N has been completed. When this occurs, the routine 350 continues to operation 356 where the “execute on task completed” activity is executed. This activity is executed each time one of the task instances 204A-204N have completed executing. From operation 356, the routine 350 proceeds to operation 306 of the routine 300.

At operation 306, a “check exit conditions” activity is executed within the context of the task action 202. This activity determines whether all of the conditions for completion of the task action 202 have been satisfied. If these conditions have not been satisfied, the routine 300 returns to operation 304, described above, where execution of the task instances 204A-204N continue. If, however, all of the exit conditions for the completion of the task action 202 have been satisfied, the routine 300 proceeds from operation 306 to operation 308. At operation 308, a “on approval completed” activity is performed. This activity is performed each time a task action 202 has been completed. The routine 300 then proceeds from operation 308 to operation 310.

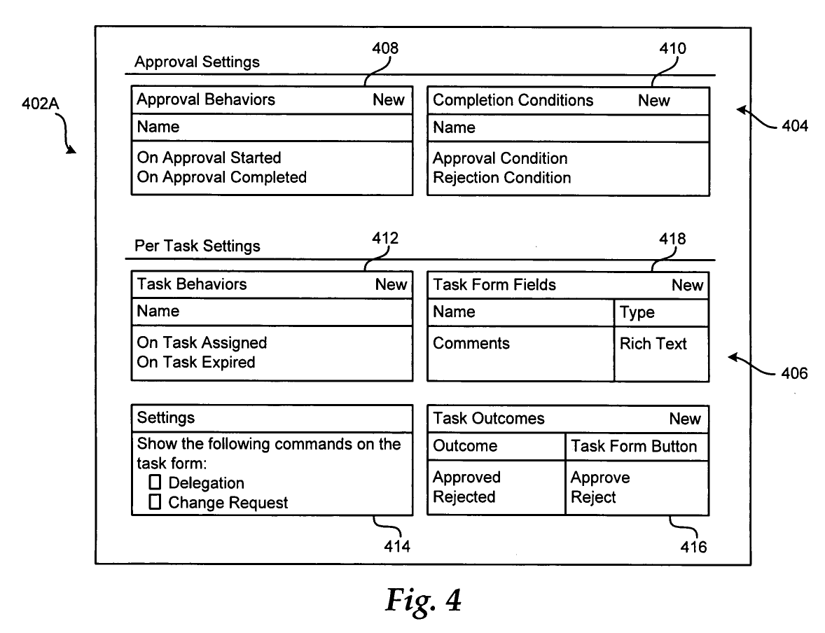

It should be appreciated that, through the embodiments presented herein, a user can customize the execution process illustrated in FIG. 3. In particular, through the user interfaces disclosed herein and provided by the authoring tool 110, a user can define the logic that is performed at the beginning of the task action 202 and the task instances 204A-204N. A user can also define activities that are to be executed at the completion of a task action 202 and the task instances 204A-204N. A user can also define conditions that signal the completion of the task action 202 and the task instances 204A-204N. A user can also define the type of information that is to be collected by the task instances 204A-204N. Additional detail regarding the provision and use of these user interfaces are provided below with respect to FIGS. 4-10.

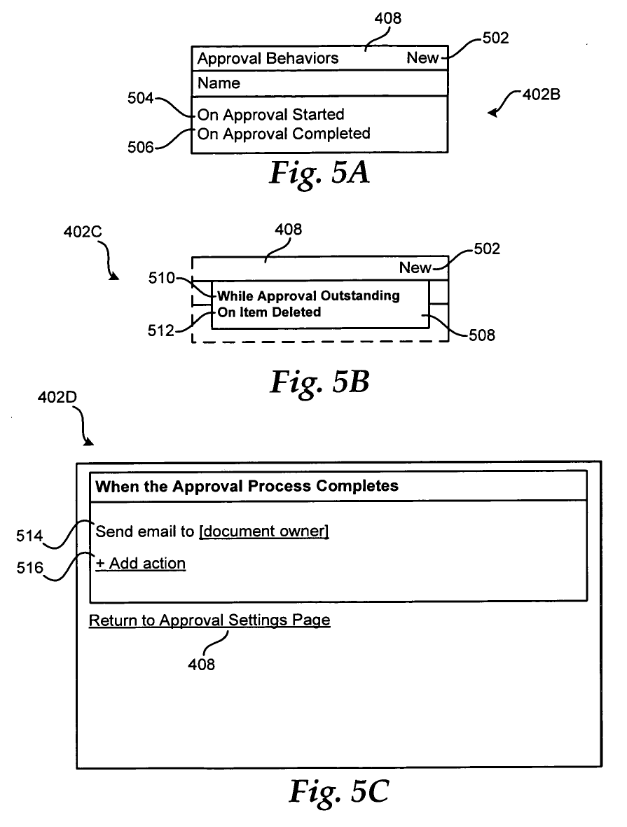

Referring now to FIG. 4, details regarding one illustrative user interface 402A provided by the authoring tool 110 will be described. As shown in FIG. 4, the user interface 402A includes a section 404 for defining aspects of the task action 202. The user interface 402A also includes a section 406 for defining the task instances 204A-204N. The section 404 includes an approval behaviors section 408. The approval behaviors section 408 includes user interface controls for defining the process behaviors 206, discussed above with reference to FIG. 2 in an approval process. As discussed above, process behaviors 206 are event handlers that execute in response to events occurring in the context of the task action 202. For instance, in the context of an approval task, the process behaviors 206 may include event handlers that execute in response to the occurrence of a task action started event, a task action outstanding event, a task action completed event, and a task action deleted event. Additional details regarding the approval behaviors section 408 are provided below with reference to FIGS. 5A-5C.

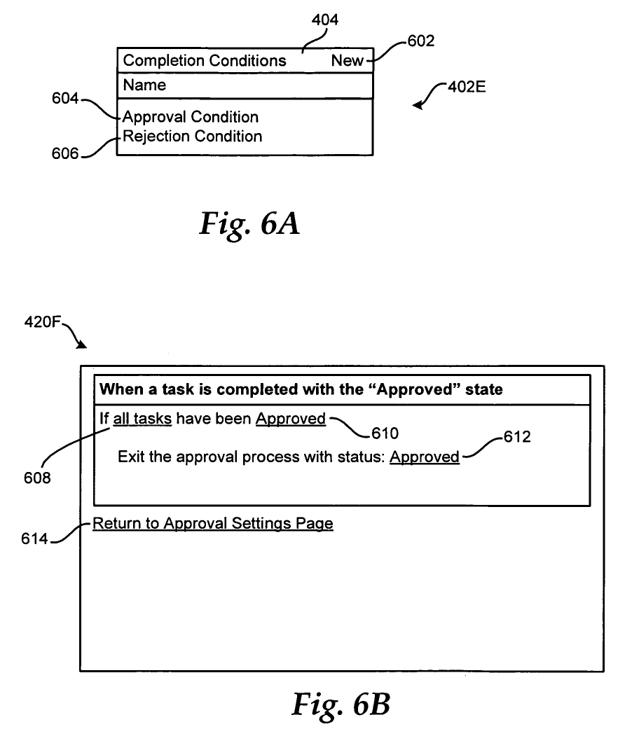

The completion conditions section 410 includes user interface controls for defining the completion conditions 208 discussed above with reference to FIG. 2. As discussed above with reference to FIG. 2, the completion conditions are event handlers that execute in response to the completion of one of the task instances 204A-204N encompassed by the task action 202. The completion conditions 208 are executed each time one of the task instances 204A-204N is completed. Additional details regarding the completion conditions section of the user interface 402A will be provided below with reference to FIGS. 6A-6B.

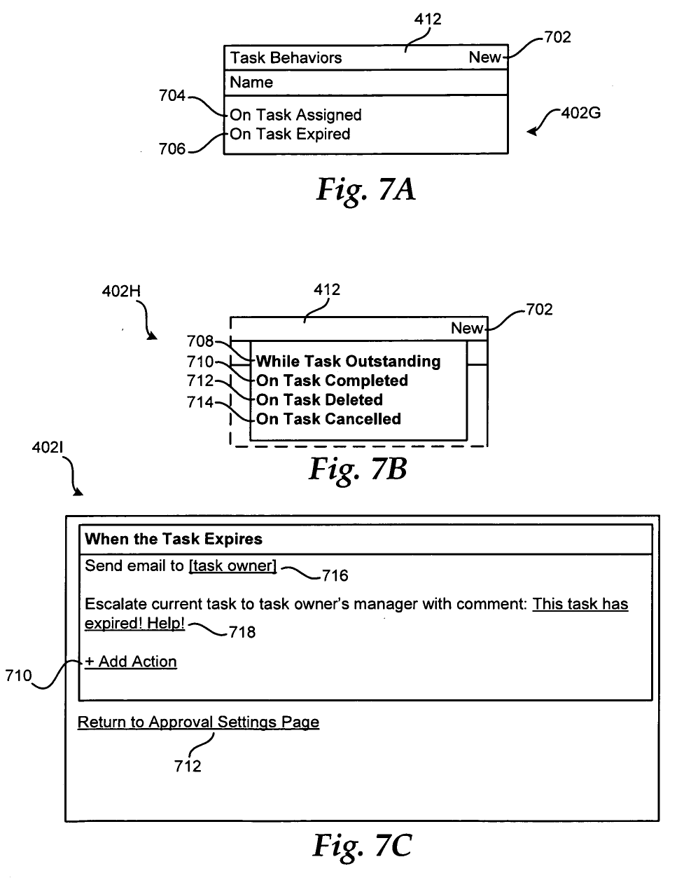

The section 406 includes a task behaviors section 412, a task form field section 418, a task outcomes section 416, and settings section 414. The task behaviors section 412 provides user interface controls for defining the task behaviors 210 discussed above with reference to FIG. 2. As described briefly above, the task behaviors 210 are event handlers that execute in response to an event occurring in the context of one of the task instances 204A-204N. For instance, the task behaviors may include a task instance assigned event, a task instance outstanding event, a task instance completed event, a task instance expired event, a task instance deleted event, or a task instance cancelled event. Additional details regarding the task behaviors section 412 will be described below with reference to FIG. 7A-7C.

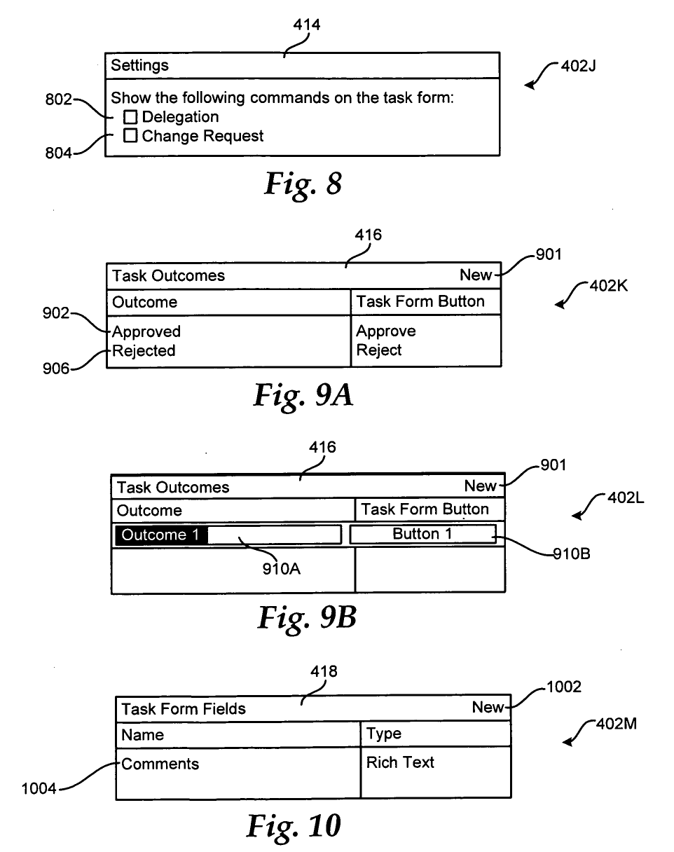

The task form fields section 418 includes user interface controls for defining one or more form fields for receiving data from a recipient of one of the task instances 204A-204N. Details regarding the contents and use of the task form fields section 418 are provided below with reference to FIG. 10. The settings section 414 includes user interface controls for defining settings applicable to the task instances 204A-204N. For instance, the task settings may define whether a participant in the custom task process can delegate an assigned task instance 204 or request a change of a task instance 204. Additional details regarding the contents and use of the settings section 414 are provided below with reference to FIG. 8.

The task outcomes section 416 includes user interface controls for defining one or more outcomes for the task instances 204A-204N that are received from the participants in the custom task process. According to the embodiments presented herein, there are two pieces of work that a task instance 204A-204N can capture from a participant. One type of work that can be captured is data via the form fields specified for the task. The other type of data is outcomes captured via user interface buttons shown to the participants. For instance, through the selection of user interface controls, the user may be able to indicate whether a document is approved or rejected. Because, however, not all tasks are defined by an approval or rejection outcome, users are permitted through the task outcomes section 416 to define the outcomes they desire for their particular tasks. Additional details regarding the form and use of the task outcomes sections 416 are provided below with respect to FIGS. 9A-9B.

Referring now to FIG. 5A, details regarding a user interface 402B provided by the authoring tool 110 that includes the approval behaviors section 408 will be described. As shown in FIG. 5A, and described briefly above, the approval behaviors section 408 may be utilized to define the process behaviors 206. In this regard, the approval behaviors section 408 shows items 504 and 506 corresponding to approval behaviors that have been defined for the task action 202. A user interface control 502 is also provided for creating a new approval behavior.

If the user interface control 502 is selected, the user interface 402C shown in FIG. 5B is displayed. The user interface 402C includes a menu 508 with items 510 and 512 corresponding to the other available process behaviors 206. Selection of one of the items 510 or 512 will cause the corresponding approval behavior to be added to the task action 202. An appropriate user interface may also be provided by the approval behaviors section 408 for removing process behaviors.

FIG. 5C shows a user interface 402D that is displayed in response to a request to edit one of the process behaviors 206 defined through the approval behaviors section 408. In the example shown in FIG. 5C, a user has requested to edit the on approval completed behavior. As discussed briefly above, the on approval completed behavior is executed following the completion of all of the task instances 204A-204N. Through the user interface 402D shown in FIG. 5C, a user can specify various activities that take place once the approval process has been competed. For instance, the item 514 corresponds to an action for sending an electronic mail message to a recipient when the approval process has completed. The item 516 may also be selected to add other actions. Once a user has completed defining the actions that are to occur when the approval process completes, the user may select the item 408 to return to the user interface 402A shown in FIG. 4.

Referring now to FIG. 6A, a user interface 402E will be described as provided by the authoring tool 110 that includes the completion conditions section 404. As described briefly above, the completion conditions section 404 includes user interface controls that can be utilized to define the completion conditions 208. In the illustrative user interface 402E shown in FIG. 6A, items 604 and 606 are displayed that correspond to an approval condition and a rejection condition, respectively. Through the selection of these items, a user can edit the approval condition or rejection condition. A user interface control 602 is also provided for adding a new completion condition.

The user interface 420F, shown in FIG. 6B, illustrates a user interface for defining one of the completion conditions 208. In the example shown in FIG. 6B, a user is editing the approval condition for a task action 202. Through the user interface 420F, a user can specify actions that are to be executed each time one of the task instances 204A-204N is competed. In the example shown in FIG. 6B, an activity has been defined that causes the task action 206 to be exited with an “approved” status when all of the task instances 204A-204N have been completed with an approved condition. Through the selection of the item 608, a user may define whether all or some of the task instances 204A-204N must have been completed in order for the defined condition to be executed. The user may select the item 610 to define whether an “approved” or “rejected” status is to be utilized in determining whether the condition has been met. Similarly, the item 612 may be selected to define whether the task action 202 is exited with an “approved” or “rejected” status following the satisfaction of each of the defined conditions. The user may select the item 614 to return to the user interface 402A shown in FIG. 4.

Referring now to FIG. 7A, details regarding an illustrative user interface 402G provided by the authoring tool 110 in the context of the task behaviors section 412 will be described. As discussed briefly above, the task behaviors section 412 provides a user interface for defining event handlers that execute in response to events occurring within the context of the task instances 204A-204N. According to embodiments, these event handlers may execute when a task instance has been assigned, when a task instance is outstanding, when a task instance has been completed, when a task instance has expired, when a task instance has been deleted, or when a task instance has been cancelled. For instance, in the illustrative user interface 402G shown in FIG. 7A, an item 704 corresponds to an on task assigned event and item 706 corresponds to an on task expired event. The user interface control 702 may be selected to add additional task behaviors 210. For instance, in response to the selection of the user interface control 702, the user interface 402H shown in FIG. 7B may be displayed. The user interface 402H shown in FIG. 7B includes the items 702, 710, 712, and 714, which correspond to additional task behaviors 210 that may be defined for the task instances 204A-204N.

Through the use of the task behaviors section 412, task behaviors may also be added, deleted, or edited. The user interface 4021 shown in FIG. 7C illustrates the editing of an on task expired event. Through the user interface 402I, a user can define the activities that take place when the task instances 204A-204N expire. For instance, through the selection of the item 716, the user may specify that an electronic mail message be sent to the task owner upon the expiration of the task instance 204. Selection of the item 718 allows the user to define the message that is transmitted to the task owner. Selection of the item 710 allows the user to add additional actions that are to occur when a task instance 204A-204N has expired. In a similar manner, a user can define the activities that occur each time a task instance 204A-204N is assigned, completed, deleted, cancelled, or is outstanding. Selection of the item 702 returns the user to the user interface 402A shown in FIG. 4.

Referring now to FIG. 8, an illustrative user interface 402J is described showing the contents of the settings section 414. The settings section 414 includes items 802A and 804 which when selected, will cause certain settings to be made available on a task form that is presented to participants in the task process. As discussed above, the task form is presented to a user in an e-mail message in one embodiment. In particular, selection of the item 802 will cause an option to be presented to a participant that allows them to delegate the assigned task instance to another participant. Selection of the item 804, will cause an option to be presented to the participant that allows them the request a change of the assignment of the task instance. It should be appreciated that other settings may also be specified through the settings section 414.

Turning now to FIG. 9A, the user interface 402K will be described illustrating aspects of the task outcomes section 416. As described briefly above, in embodiments herein each of the task instances 204A-204N can capture data from a participant via form fields provided in a task form or capture outcomes via user interface buttons presented on the task form. Since not all tasks are defined by approval or rejection outcomes, the task outcome section 416 can be utilized to allow users to define the outcomes they desire for their particular tasks.

The task outcome section 416 includes items 902A and 906 corresponding to the approved and rejected tasks, respectively, and defines buttons corresponding to those outcomes. The user interface control 901 may be selected to add a new outcome. In response to such a selection, the user interface 402L shown in FIG. 9B is displayed. Through the user interface 402L, a user can edit the contents of the field 910A to specify an outcome and edit the contents of the field 910B to specify the title of the button corresponding to the defined outcome. In this manner, any number of additional task outcomes may be defined by a user.

Turning now to FIG. 10, the user interface 402M will be described that illustrates aspects of the task form fields section 418. In addition to the task outcomes described above, task form fields represent the other type of work that a task form presented to a participant in a task process can collect. Through the use of the task form field section 418, a user can define the task form fields that are presented to each participant. In the example shown in FIG. 10, an item 1004 corresponds to a comments field that is of a rich text data type. Selection of the user interface control 1002 allows a user to define a name and data type for other task form fields to be collected.

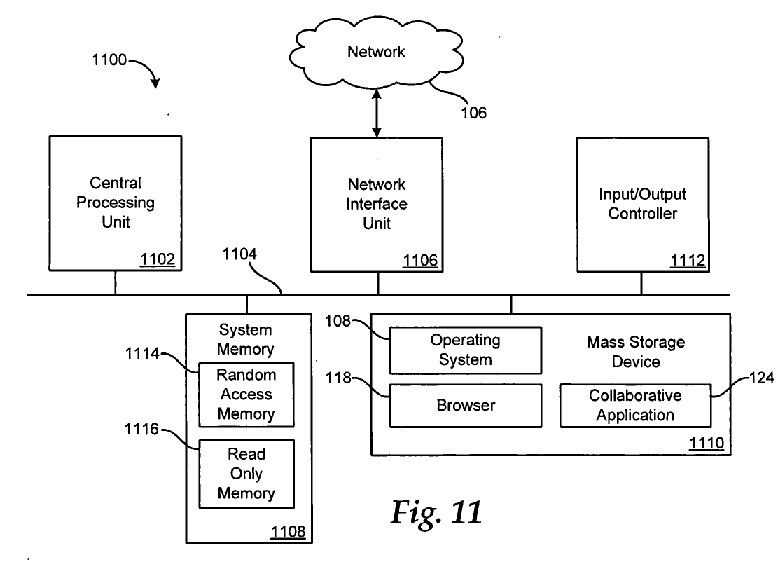

Referring now to FIG. 11, an illustrative computer architecture for a computer 1200 utilized in the various embodiments presented herein will be discussed. The computer architecture shown in FIG. 11 illustrates a conventional desktop, laptop computer, or server computer, and may be utilized to embody the client computer 102 and the server computer 104. The illustrative computer architecture shown in FIG. 11 includes a central processing unit 1102 (“CPU”), a system memory 1108, including a random access memory 1114 (“RAM”) and a read-only memory (“ROM”) 1116, and a system bus 1104 that couples the memory to the CPU 1102. A basic input/output system containing the basic routines that help to transfer information between elements within the computer 1100, such as during startup, is stored in the ROM 1116. The computer 1100 further includes a mass storage device 1110 for storing an operating system 108, application programs, and other program modules, which have been described in detail above.

The mass storage device 1110 is connected to the CPU 1102 through a mass storage controller (not shown) connected to the bus 1104. The mass storage device 1110 and its associated computer-readable media provide non-volatile storage for the computer 1100. Although the description of computer-readable media contained herein refers to a mass storage device, such as a hard disk or CD-ROM drive, it should be appreciated by those skilled in the art that computer-readable media can be any available media that can be accessed by the computer 1100.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1100.

According to various embodiments, the computer 1100 may operate in a networked environment using logical connections to remote computers through a network 106, such as the Internet. The computer 1100 may connect to the network 106 through a network interface unit 1106 connected to the bus 1104. It should be appreciated that the network interface unit 1106 may also be utilized to connect to other types of networks and remote computer systems. The computer 1100 may also include an input/output controller 1112 for receiving and processing input from a number of other devices, including a keyboard, mouse, or electronic stylus (not shown in FIG. 11). Similarly, an input/output controller may provide output to a display screen, a printer, or other type of output device (also not shown in FIG. 11).

As mentioned briefly above, a number of program modules and data files may be stored in the mass storage device 1110 and RAM 1114 of the computer 1100, including an operating system 108 suitable for controlling the operation of a networked desktop or server computer, such as the WINDOWS XP operating system from MICROSOFT CORPORATION of Redmond, Wash., or the WINDOWS VISTA operating system, also from MICROSOFT CORPORATION. The mass storage device 1110 and RAM 1114 may also store one or more program modules. In particular, the mass storage device 1110 and the RAM 1114 may store the browser 118, the collaborative application 124, and the other program modules described above. Other program modules not illustrated in FIG. 11 may also be stored in the mass storage device 1110 and utilized by the computer 1100.

Based on the foregoing, it should be appreciated that technologies for defining and implementing custom task processes are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for defining a custom task process, the method comprising:
providing a first user interface for defining a task action, the task action encompassing one or more task instances; and
providing a second user interface for defining the one or more task instances.

2. The method of claim 1, wherein the task action further comprises one or more process behaviors.

3. The method of claim 2, wherein the process behaviors comprise one or more event handlers that execute in response to an event occurring in a context of the task action.

4. The method of claim 3, wherein the event occurring in the context of the task action comprises one of a task action started event, a task action outstanding event, a task action completed event, and a task action deleted event.

5. The method of claim 2, wherein the task action further comprises one or more completion conditions.

6. The method of claim 5, wherein the completion conditions comprise one or more event handlers that execute in response to the completion of a task instance encompassed by the task action.

7. The method of claim 1, wherein each task instance comprises one or more task behaviors.

8. The method of claim 7, wherein the task behaviors comprise one or more event handlers that execute in response to an event occurring in a context of a task instance.

9. The method of claim 8, wherein the event occurring in the context of a task instance comprises one or more of a task instance assigned event, a task instance outstanding event, a task instance completed event, a task instance expired event, a task instance deleted event, or a task instance cancelled event.

10. The method of claim 7, wherein each task instance defines zero or more form fields for receiving data from a recipient of a task instance.

11. The method of claim 10, wherein each task instance further comprises one or more task outcomes.

12. The method of claim 11, wherein the task outcomes define one or more outcomes for a task instance to be received from a participant in the custom task process.

13. The method of claim 1, wherein each task instance comprises one or more task settings, the task settings defining whether a participant in the custom task process can delegate a task instance or request a change of a task instance.

14. A method for executing a custom task process, the method comprising:
executing a task action, the task action encompassing one or more task instances; and
executing the one or more task instances.

15. The method of claim 14, wherein executing the task action comprises executing one or more process behaviors, the process behaviors comprising one or more event handlers that execute in response to the occurrence of one or more of a task action started event, a task action outstanding event, a task action completed event, and a task action deleted event.

16. The method of claim 15, wherein executing the task action further comprises executing one or more completion conditions, the completion conditions comprising one or more event handlers that execute in response to the completion of a task instance encompassed by the task action.

17. The method of claim 16, wherein executing the one or more task instances comprises executing one or more task behaviors, the task behaviors comprising one or more event handlers that execute in response to the occurrence of one or more of a task instance assigned event, a task instance outstanding event, a task instance completed event, a task instance expired event, a task instance deleted event, or a task instance cancelled event.

18. The method of claim 17, wherein each of the task instances further comprises one or more task outcomes.

19. The method of claim 18, wherein the task outcomes define one or more outcomes for a task instance to be received from a participant in the custom task process.

20. A computer storage medium having computer-executable instructions stored therein which, when executed by a computer, cause the computer to:
provide a user interface for defining a custom task process, the user interface comprising one or more user interface controls for defining a task action that encompasses one or more task instances;
receive data through the user interface defining one or more process behaviors and completion conditions for the task action;
receive data through the user interface defining one or more task outcomes and task behaviors for the one or more task instances; and to
execute the custom task process by executing the task action and the one or more task instances.
